(19) United States
(12) Patent Application Publication
(10) Pub. No.: US 2003/0133735 A1
(43) Pub. Date: Jul. 17, 2003

(54) Sound cover for automatic time and date stamp machines

(76) Inventor: Gary David Munyon, Concord, CA (US)

Correspondence Address: Bruce H. Johnsonbaugh, Eckhoff & Hoppe, Suite 3125, 333 Market Street, San Francisco, CA, 94105, US

(21) Appl. No.: 10/339,714

(22) Filed: Jan. 8, 2003

Related U.S. Application Data
(60) Provisional application No. 60/348,095, filed on Jan. 14, 2002.

(51) Int. Cl. B41J 29/08

(52) U.S. Cl. 400/690

(57) ABSTRACT

A removable sound cover for automatic time and date stamp machines is provided. The time and date stamp machine has an elongated recess in its body for slidably receiving time cards or other papers. The removable sound cover includes a housing adapted to enclose the time and date stamp machine and an elongated recess formed in the cover housing to allow time cards or other papers to be slid into the elongated recess in the time and date stamp machine. The removable sound cover carries sound deadening material on its inner walls to attenuate noise caused by the time and date stamp machine. The front wall of the removable housing is transparent to allow the viewing of the clock provided on the face of most time and date stamp machines. The sound deadening material may be serrated to increase the sound attenuation characteristics of the cover.

### CROSS-REFERENCE TO RELATED APPLICATION

This application claims the benefit of and priority from U.S. provisional application Serial No. 60/348,095 dated Jan. 14, 2002.

### BACKGROUND AND BRIEF SUMMARY OF INVENTION

This invention relates primarily to a device for reducing noise made by automatic time and date stamp machines. More particularly, the invention provides a removable sound cover which is intended to be placed over an automatic time and date stamp machine. The sound cover when in place does not affect the operation of the automatic time and date stamp machine in any way. The face of the sound cover is transparent to allow viewing of the clock face. The sound cover includes a recess which overlies the recess in the automatic time and date stamp machine so that paper such as time cards or other papers may be readily inserted into the machine and be stamped.

A primary object of the invention is to provide a sound cover that dramatically reduces the noise level of automatic time and date stamp machines.

A further object is to provide a sound cover which is easily and completely removable from the automatic time and date stamp machine.

A further advantage of the invention is to provide a sound cover which includes a transparent front face so that the clock face of the automatic time and date stamp machine is clearly displayed.

A further object is to provide a sound cover for time and date stamp machines which includes a paper guide recess for easy use.

Yet another object is to provide a sound cover which is attractive and durable and fits most major commercially available brands of automatic time and date stamp machines.

Other objects and advantages will become apparent from the following description and drawings wherein:

### BRIEF DESCRIPTION OF THE DRAWINGS

FIG. 1 is a perspective view of the removable sound cover of the present invention;

FIG. 2 is a section on the line 2-2 of FIG. 1;

FIG. 3 is a sectional view of an alternate embodiment of the invention; and

FIG. 4 is a perspective view showing the removable sound cover together with a time and date stamp machine.

### DETAILED DESCRIPTION OF THE DRAWINGS

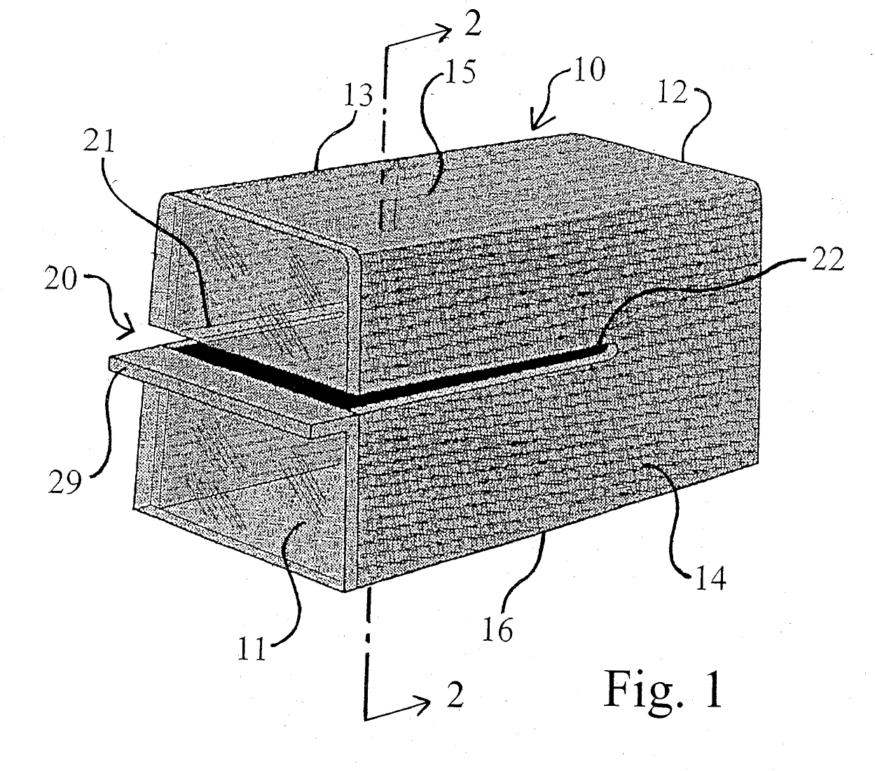

FIG. 1 is a perspective view of the sound cover of the present invention shown generally as 10. The sound cover is essentially a rectangular box having a transparent front wall 11, opaque back wall 12 and side walls 13 and 14 and an opaque top 15. The bottom 16 is open so that the sound cover 10 may simply be placed over a prior art automatic time and date stamp machine (not shown). The dimensions of the sound cover 10 are chosen to match the size of the particular brand and model of machine to which it is applied. A paper guide recess 20 is formed in front wall 11 and has extensions 21 and 22 in side walls 13 and 14, respectively. The recess 20 is positioned to correspond with the recess in the automatic time and date stamp machine so that the user simply slides the paper into recess 20 of the sound cover 10 and it is guided into the recess of the time and date stamp machine. A guide lip 29 is provided which assists in guiding any paper into the time and date stamp machine. Guide lip 29 is a horizontal ledge extending outwardly from front wall 11. Guide lip 29 is positioned at the lower edge of recess 20.

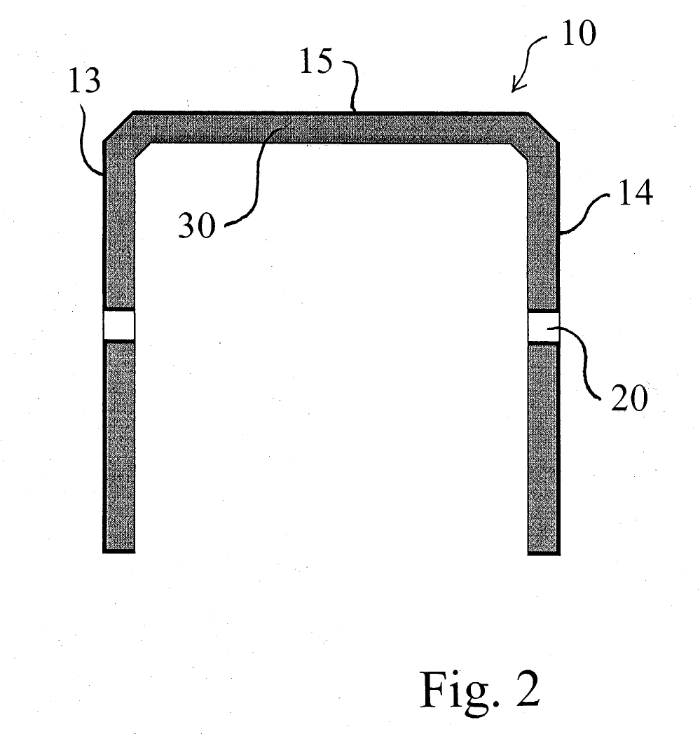

FIG. 2 is a sectional view which shows the sound deadening material 30 applied to the interior surface of sides walls 13 and 14, top 15 and rear wall 12. The sound deadening material 30 may be Styrofoam or other sound deadening material. The sound deadening material 30 shown in FIG. 2 has a smooth inner surface. Alternate materials may include paper or plastic and may include serrated or roughened surfaces which tend to further attenuate the sound.

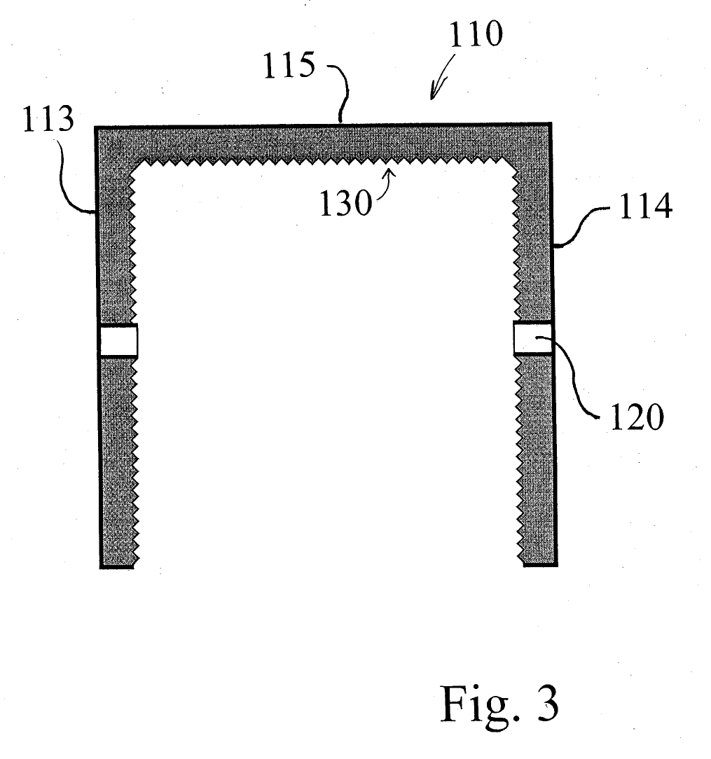

FIG. 3 is a sectional view which illustrates a second embodiment 110 of the invention. The only difference between sound cover 110 and sound cover 10 is the use of a serrated or sawtooth sound deadening material 130. Material 130 may be any material which effectively attenuates noise.

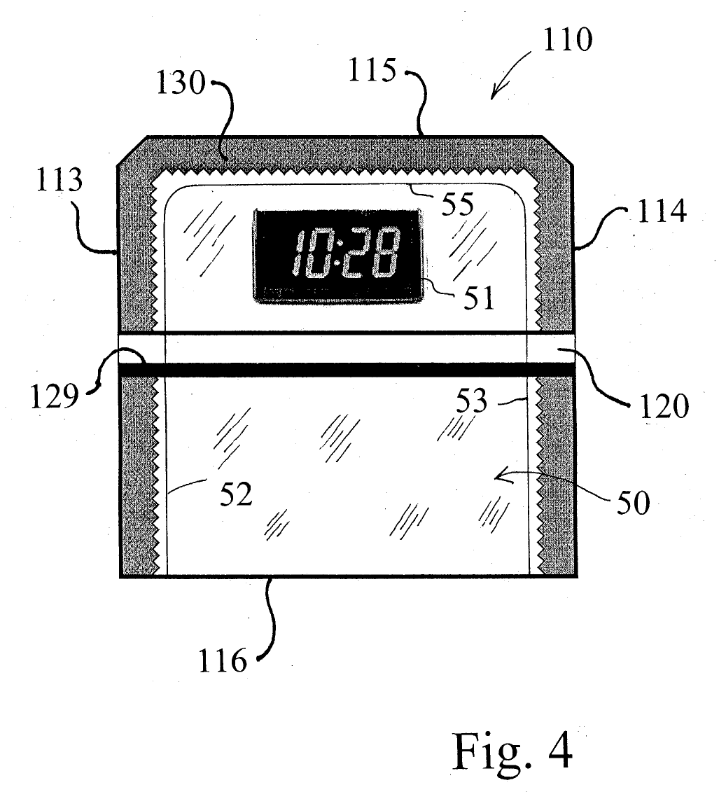

FIG. 4 is a front elevational view of the sound cover 110 shown in FIG. 3 together with time and date stamp machine 50. The time and date stamp machine 50 has a digital clock display 51, side walls 52,53 and top 55. Removable sound cover 110 simply sits over time and date stamp machine 50. Cover 110 is thereby readily removed to allow servicing of time and date stamp machine 50. It is also within the scope of the invention to provide a removable connection or connections between sound cover 110 and time and date stamp machine 50.

The foregoing description of the invention has been presented for purposes of illustration and description and is not intended to be exhaustive or to limit the invention to the precise form disclosed. Modifications and variations are possible in light of the above teaching. The embodiments were chosen and described to best explain the principles of the invention and its practical application to thereby enable others skilled in the art to best use the invention in various embodiments and with various modifications suited to the particular use contemplated. The scope of the invention is to be defined by the following claims.

What is claimed is:

1. A removable sound cover for use in conjunction with an automatic time and date stamp machine, wherein said time and date stamp machine includes a body and an elongated recess in said body for slidably receiving time cards and/or other papers, said removable sound cover comprising:
a housing adapted to enclose said time and date stamp machine,
an elongated recess formed in said housing, said recess adapted to allow time cards and/or other papers to be slid into said recess in said time and date stamp machine, and
sound deadening means carried inside said housing to attenuate noise caused by said time and date stamping machine.

2. The apparatus of claim 1 wherein said time and date stamp machine has a front surface which carries a clock and wherein said housing of said sound cover includes a transparent front wall which covers said front wall of the time and date stamp machine, allowing users to view said clock.

3. The apparatus of claim 1 wherein said sound deadening means is styrofoam.

4. The apparatus of claim 3 wherein said styrofoam is serrated.

5. In combination:
an automatic time and date stamp machine, wherein said time and date stamp machine includes a body and an elongated recess in said body for slidably receiving time cards and/or other papers,
and a removable sound cover comprising:
a housing adapted to enclose said time and date stamp machine,
an elongated recess formed in said housing, said recess adapted to allow time cards and/or other papers to be slid into said recess in said time and date stamp machine, and
sound deadening means carried inside said housing to attenuate noise caused by said time and date stamping machine.
